(19) United States
(12) Patent Application Publication
(10) Pub. No.: US 2010/0032529 A1
(43) Pub. Date: Feb. 11, 2010

(54) SYSTEM, METHOD AND COMPUTER READABLE MEDIUM FOR TRACKING A RAILYARD INVENTORY

(76) Inventors: James Kiss, Melbourne, FL (US); Robert Thomas Oliveira, Melbourne, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/187,449

(22) Filed: Aug. 7, 2008

(51) Int. Cl. B61L 25/04; G06F 17/30

(52) U.S. Cl. 246/122 R; 707/104.1; 707/200; 707/E17.005; 707/E17.044

(57) ABSTRACT

A system for tracking a rail yard inventory may be incorporated in a rail yard that has a plurality of tracks on which a plurality of railcars in a train are moved and arranged wherein each track is associated with a destination of the railcars on the track. A controller, responsive to signals from sensors, counts the number of railcars that enter and exit a track to determine if railcars have been added or removed from the train. The controller updates the railcar sequence in the train and a database having data relative to the location of each railcar in the rail yard and sequence in which railcars are linked on a track.

### BACKGROUND OF THE INVENTION

An embodiment of the invention relates to systems and methods that detect movement of vehicles on designated pathways. More specifically, the invention pertains to such systems and methods that are used to detect movement of vehicles within a staging yard (e.g., railcars on tracks within a rail yard).

Rail yards are staging locations for railcars that typically have a multitude of tracks. Some rail yards include classification yards/tracks that serve as a potential destination location for railcars. Accordingly, the railcars are moved and arranged on the tracks according to a predetermined destination of the railcars. In most cases, a trip plan is created that provides for a starting location and destination location for each railcar in a train. In other cases railroad personnel on site determine placement of cars using real time-based judgment. The trip plan may include one or more intermediate destinations or stops at classification yards to classify the railcars according to the railcars' next stops or destinations.

Railcar movement into and out of rail yards is routinely tracked by management information systems. Each of the railcars in a train, and the locomotive of a train, is identified with specific codes or a serial number. The management information systems can utilize Automated Equipment Identification (AEI) tags and readers to locate railcars on a track or can be manually updated based on inspection reports. Additionally, railcars and locomotives may include an AEI tag that includes stored data relative to an identification of the railcar or locomotive. An AEI reader may be positioned on the wayside of the railroad track at an exit or entrance of the rail yard to read the AEI tags on the railcars and locomotives in a train. The AEI readers transmit information signals that provide the identification and location for each locomotive and railcar in the train. Alternatively, a railroad agent or system may visually inspect each car or locomotive and record the identity of each railcar and the railcar sequence in the train. The information concerning the train profile includes the identification of the individual railcars making up the train. This information may be verified with a train manifest, which includes a list of the railcars associated with a locomotive ID, and the destinations for each railcar in a train.

Once the train enters the rail yard, one or more operators that are supervising or controlling the movement of the locomotive in the rail yard manually track movement and location of the individual railcars making up the railcar inventory. The operator moves the locomotive through the rail yard dropping and adding railcars as required for meeting local rail yard plans and objectives. Where necessary, the operator may deviate from a prescribed plan, resulting in placement of a railcar in a location other than originally planned. As a result of these ad-hoc moves, a single operator may be the only person who knows the location of a railcar in the rail yard. If the operators forget the location of railcars in the rail yard, or otherwise make an error in building a train, railcars may be lost or directed to the wrong destinations

Sensors or wheel detectors are used in classification yards; however, not for the purpose of tracking a rail yard inventory. The sensors or wheel detectors are used to generally detect movement of a railcar onto or off of a track. Other applications may include determining direction of movement of a train or measuring the speed of a railcar. However, sensors or wheel detectors in classification yards are not used to track a rail yard inventory.

### BRIEF DESCRIPTION OF THE INVENTION

Embodiments of the invention for a system for tracking a vehicle inventory may be incorporated in a staging yard wherein a plurality of the vehicles are connected in a series and are moved and arranged on a plurality of designated pathways in the staging yard by a powered vehicle. The system comprises a plurality of sensors each of which is associated with a designated pathway in the staging yard for detecting a vehicle entering or exiting the pathway. (For example, each sensor may be positioned in the staging yard relative to a pathway.) Each sensor transmits one or more signals indicating the vehicle has entered or exited the pathway and an identification of the associated pathway.

One or more controllers have data relative to the connected series of vehicles in the staging yard. This data, collectively referred to in some embodiments as a profile of the connected series of vehicles, may include a total number of vehicles in the series, and a sequence in which the vehicles are linked together and are identified relative to reference vehicle. The one or more controllers, responsive to movement of the vehicles in the staging yard and to the signals received from the sensors, store in a memory the number of vehicles in the connected series having entered or exited each pathway in the staging yard, and the sequence in which the railcars are linked together on each track in the rail yard. In addition, as vehicles are dropped and added to the series of vehicles, the controller is configured to update the sequence of the vehicles, according to the vehicle's identifiers, that make up the series. The controller may also update a database that includes data relative to the identification of each vehicle remaining on each pathway and the sequence in which these remaining vehicles are linked on a respective pathway.

Embodiments of the invention may also be described as and include a method for tracking a staging yard inventory. The method comprises providing data relative to a train or other series of linked vehicles in the staging yard. The data may include a total number of vehicles in the series of vehicles, an identifier for each vehicle in the series of vehicles, and a sequence in which the vehicles are linked together (with respect to a reference vehicle or otherwise). The method also includes steps of counting the number of vehicles that enter and exit a pathway in the staging yard; identifying each vehicle that enters and exits the pathway in the staging yard; and storing in a memory, for each pathway in the staging yard, data relative to the number of vehicles in the series having entered and exited the pathway, the identifier for each vehicle having entered and exited the pathway, and the sequence in which the vehicles are linked together or otherwise arranged on the pathway.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 is a schematic illustration of a train in a rail yard.

FIG. 1A is a schematic diagram illustrating two inventory railcars on track T1 in the rail yard with AEI tags and identifiers.

FIG. 1B is a schematic diagram illustrating three inventory railcars on track T5 in the rail yard with AEI tags and identifiers.

FIG. 1C is a schematic diagram of a train with a locomotive and railcars having AEI tags and identifiers, and the railcars having been counted in the system and sequenced according numbers RC01-RC06 and their identifiers.

FIG. 2 is a partial schematic illustration of the rail yard with the train entering track T4 in the rail yard.

FIG. 3 is a partial schematic illustration of the rail yard with the train having dropped three railcars on track T4.

FIG. 4 is a partial schematic illustration of the rail yard with the train moving the railcars retained in the train from track T4 to track T1.

FIG. 5 is a partial schematic illustration of the rail yard with the train having added the two railcars on track T1 that were dropped by a previous train or trains.

FIGS. 6A and 6B are schematic illustrations of a wheel detector positioned relative to a track.

FIG. 7 is a flow chart describing steps for an embodiment of the invention.

### DETAILED DESCRIPTION OF THE INVENTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained. While the invention is described below in reference to tracking the movement of railcars in a rail yard, the invention is not so limited. The invention may be used with other vehicles including marine vessels, off-highway vehicles, on-road vehicles, etc. The term “powered vehicle” as used herein shall comprise the vehicles that have an onboard power source sufficient to propel the vehicle and others in a series of vehicles. In the case of trains traveling on railroad tracks, the locomotive is the powered vehicle.

Before describing in detail the particular method and apparatus for controlling of movement of a train in accordance with the present invention, it should be observed that the present invention resides primarily in a novel combination of hardware and software elements related to said method and apparatus. Accordingly, the hardware and software elements have been represented by conventional elements in the drawings, showing only those specific details that are pertinent to the present invention, so as not to obscure the disclosure with structural details that will be readily apparent to those skilled in the art having the benefit of the description herein.

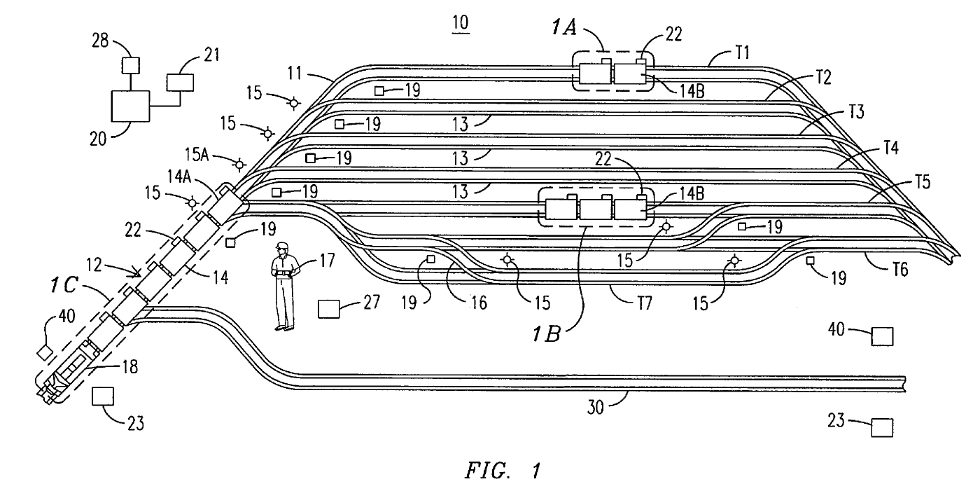

With respect to FIG. 1, there is schematically illustrated a rail yard 10 that includes a main track 11 (also designated TI) on which a train 12 moves to enter or exit one or more of a plurality of tracks 13. In FIG. 1 there are seven tracks 13, which are further distinguished from one another with the alphanumeric references T1-T7. In addition, the rail yard 10 may also include gate tracks or gates 16 that connect adjacent destination tracks 13 to move the railcars between tracks 13. Switches 15 are positioned at the junctions between the main track 11 and each track 13 to control movement to the train 12 in the rail yard 10. Switches 15 are also positioned at the junctions of the gates 16 and the tracks 13. The rail yard 10 may also include a departure track 30 on which the railcars 14 may be positioned for departing from the rail yard 10. In the described example, the departure track 30 may also be used as a bypass to avoid traffic or railcars on the tracks 13.

The train 12 includes at least one locomotive 18 and a plurality of railcars 14 that are linked together and to the locomotive 18. An operator 17 located on-board or off-board the locomotive 18 controls movement of the locomotive 18 and train 12 in the rail yard 10 to position railcars 14 on the tracks 13 according to a predetermined destination. In the example shown in FIG. 1 an operator 17 is shown off-board remotely controlling the locomotive 18 with a remote control unit 27. Locomotives that are used to move railcars in a rail yard are known as switch locomotives, as distinguished from road locomotives which are used in a train to transport the railcars on a main line from destination to destination. When a train arrives at a rail yard 10 the road locomotive is typically removed from the train on an arrival track and replaced with a switch locomotive. In addition, the brake pipe pressure in the train brake line is released at each railcar, so the railcars are free wheeling and the braking of the train is only present on the switch locomotive.

As the train 12 moves through the yard 10, the switches 15 are activated to move the train 12 from the main track 11 to the tracks 13 or from one track 13 to another. Wheel detectors or sensors 19 are positioned along the tracks 11, 13 and 30 adjacent to the switches 15 to provide information concerning progress of a railcar 14 such as the speed the railcar 14 is traveling, the direction of movement of the railcars 14, and the location of the railcars 14 and train 12 in the rail yard 10. Sensors 19 are those typically used to detect occupancy of a track 13 such as axle counters, track circuits, loop detectors, and/or optical sensors.

In the below described rail yard 10, there are those railcars 14 that make up the train 12, and those railcars 14B that are present in the rail yard 10 when a train 12 arrives or leaves the rail yard 10. An embodiment of the system for tracking rail yard inventory including the railcars 14 of the train 12 and railcars 14B in the yard 10 comprises the sensors 19 and one or more wayside controllers 20, which are programmed or otherwise configured to count the railcars 14 as they are entering or exiting the main track 11 or destination tracks 13. With respect to FIG. 1, train 12 has entered the rail yard 10, and railcars 14B not in the train 12 are positioned on tracks 13 for pickup. A rail yard inventory database 21, accessible by the controller 20, is provided and includes data relative to the identification of each railcar 14B in the classification yard 10, the location of each railcar 14B and/or identification of each track 13 on which a railcar 14B is positioned, and the sequence in which a plurality of the railcars 14B are positioned on each track 13 As railcars 14 are dropped from the train 12 or railcars 14B are added to the train 12 the controller 20 updates the inventory database 21 to reflect the railcars 14B remaining on the tracks 13.

In reference to FIGS. 1, 1A and 1B, there are five railcars 14B on the tracks 13, and each railcar 14B has an identifier (explained in more detail below) unique to a respective railcar 14B. So the database 21 may include data relative to a track number, the identity of each railcar on each track 13, and the sequence in which the railcars 14B are arranged on the track. With respect to FIG. 1, the below Table I represents the data relative to the identification of the railcars 14B and their location in the rail yard 10.

TABLE I

| TRACK 1 | TRACK 5 |
|---|---|
| ABC001 | XYZ001 |
| ABC002 | XYZ002 |
| | XYZ003 |

When the train 12 enters the rail yard 10 the controller 20 is activated to initiate the algorithms or programs for tracking the rail yard 10 inventory. The controller 20 may be configured so it is manually activated, or it may include a radio frequency module for remote engagement by the operator 17 using the remote control unit 27. In addition, or alternatively, the controller 20 may be remotely engaged by a locomotive onboard operating system (not shown). Initially, an identification of the train 12 including the identifier for the locomotive 18 and each railcar 14, and the sequence in which the railcars 14 are connected together and to the locomotive 18, is provided and entered into the controller/database. The sequence of railcars may be determined from a reference vehicle such as a lead railcar 14A to the locomotive 18. Alternatively, the reference vehicle may include the locomotive 18, or a railcar adjacent the locomotive 18, and the sequence of the railcars 14 is determined from the reference vehicle to the lead railcar 14A.

The identifier data or information is an alphanumeric symbol posted on the side of, and unique to each railcar 12. This data may be entered into the controller 20 manually from a train manifest in the possession of the operator 17, or the data entry may be automated. For example, rail yards 10 often have AEI readers 23 positioned at an entrance or exit of the rail yard 10. An AEI tag 22 is mounted on each of the railcars 14 and locomotive 18 and contains data relative to the respective railcar 14 and locomotive 18, including the identifier unique to a railcar 14 or locomotive 18. As the train 12 enters the rail yard 10, the AEI reader 23 reads the data on the AEI tags 22 mounted on each railcar 14 and locomotive 18 and transmits signals to the controller 20 that include data relative to the railcars 14 identifiers. Accordingly, the controller 20 may be equipped with a radio frequency module 28 for a communication link with the AEI readers and other components (including the remote control unit 27 or locomotive onboard operating system) of the classification rail yard 10. The use and operation of AEI tags and readers in the locomotive industry are well known to those skilled in the art.

The controller 20 may be programmed to count the railcars 14 as the train manifest data is entered manually or automatically, thereby creating a railcar sequence as provided in Table II below and referenced in FIG. 1C:

TABLE II

| RAILCAR/LOCO IDENTIFIER | RAILCAR/LOCO COUNT |
|---|---|
| MNP001 | RCO1 |
| MNP002 | RC02 |
| MNP003 | RC03 |
| MNP004 | RC04 |
| MNP005 | RC05 |
| MNP006 | RC06 |

Only six railcars are illustrated in this example; however, a train may include many more railcars, because trains may be as long as a mile or even longer.

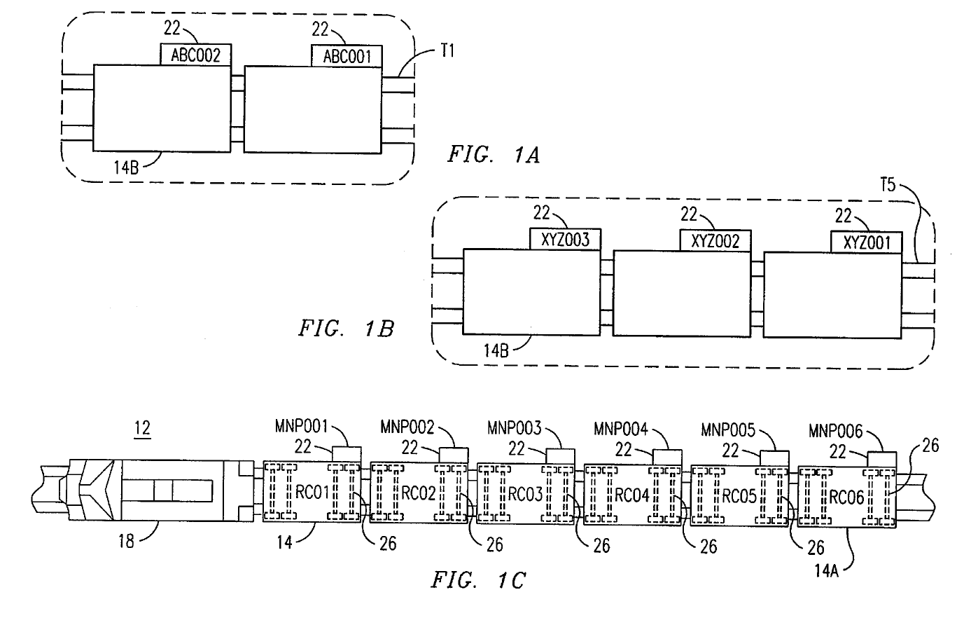

In addition, the controller 20 may be configured to count the railcars 14 as they pass the wheel detectors or sensors 19. By way of example, and with respect to FIG. 2, a switch 15A has been actuated or opened so that the train 12 has entered track T4. As the railcars 14 pass the sensors 19 at the switch 15A for track T4, the sensors 19 transmit signals 25 to the controller 20 indicating a wheel or axle 26 on a railcar 14 has entered the track T4. Each sensor 19 in the classification yard 10 is associated with a track 13 and switch 15, and the controller 20 determines which sensors 19 have been activated and the track T4 associated with the sensors 19.

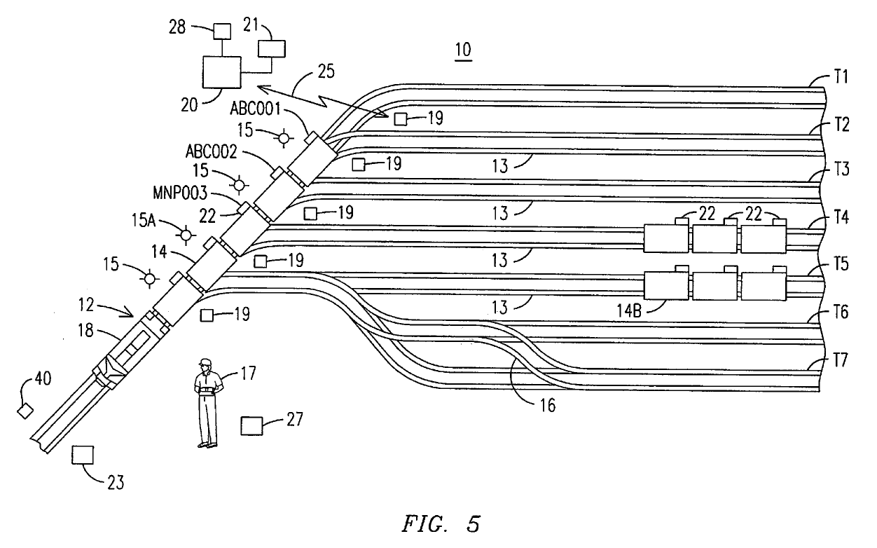

As each railcar 14 enters the track T4, the sensor 19 and controller 20 count the wheels or axles 26 on the railcar 14, and when a sufficient number of wheels or axles 26 have been counted for a railcar 14 to be on track T4 a railcar 14 is counted and determined to be on the track 13. Railcars 14 typically have four axles, so when the fourth or last axle is counted a railcar 14 is counted. Algorithms known to those skilled in the art may also be used to assign a number when fewer than four axles have been counted. In addition, the controller 20 may be programmed to determine the direction in which the railcars 14 are rolling or moving responsive to the signals 25 received from the sensors 19, so that the controller 20 may determine if the railcars 14 are entering or exiting a track 13. For example, and with respect to FIGS. 6A and 6B, a sensor 19 such as a proximity sensor may be an integrated module that includes two sensors 19A and 19B, so as the wheel 26 passes the sensors 19A and 19B, the controller 20 is able to determine in which direction the railcar 14 is traveling depending the sequence in which the sensors 19A and 19B are activated.

With respect to FIG. 2, the sensors 19 and controller 20 have counted a total of twenty-four wheels or axles 26 entering track T4. Accordingly, six railcars 14 are on the track T4, and the controller 20 may assign each of the railcars 14 a number, RC01 through RC06, and each assigned number is associated with a railcar identifier as represented in the above Table I. In addition, in Table III, the controller 20 identifies the track T4 on which the railcars 14 (assigned numbers RC01 through RC06) are positioned.

TABLE III

| RAILCAR/LOCO IDENTIFIER | RAILCAR/LOCO COUNT | TRACK |
|---|---|---|
| MNP001 | RC01 | T4 |
| MNP002 | RC02 | T4 |
| MNP003 | RC03 | T4 |
| MNP004 | RC04 | T4 |
| MNP005 | RC05 | T4 |
| MNP006 | RC06 | T4 |

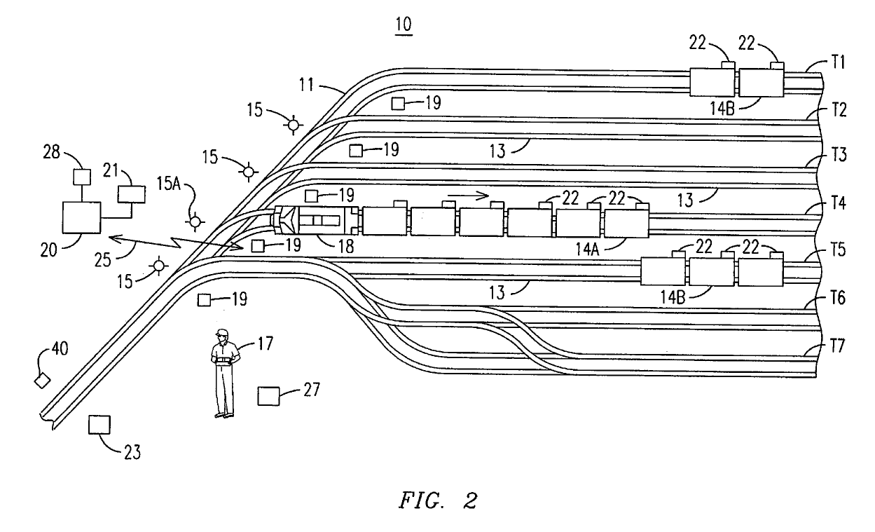

With respect to FIG. 3, the train 12 has moved off of track T4 on to main track 11 having dropped three railcars 14 in the train 12. As the remaining three railcars RC01 (MNP001), RC02 (MNP002) and RC03 (MNP003) pass sensors 19 at switch 15A, the sensors 19 and controller 20 count the wheels or axles 26 on these railcars 14. The sensors 19 transmit signals indicating the direction of movement (off the track) and the number of wheels or axles 26 passing the sensors 19. The controller 20 counts only twelve axles 26, because the three railcars RC04, RC05 and RC06 have been left on the track T4. The controller 20 is programmed to determine that twelve axles 26 or three railcars 14 (See Table II; MNP004; MNP005; and, MNP006) remain on track T4. Accordingly, the controller 20 may update the sequence of the railcars 14 in the train 12 and the railcar count may be updated as reflected in Table IV below:

TABLE IV

| RAILCAR/LOCO IDENTIFIER | RAILCAR/LOCO COUNT |
|---|---|
| MNP001 | RC01 |
| MNP002 | RC02 |
| MNP003 | RC03 |

The controller 20 may be programmed to update the inventory database 21 to reflect that the three railcars MNP004, MNP005 and MNP006 were left on track T4 as reflected in the below Table V:

TABLE V

| TRACK 1 | TRACK 4 | TRACK 5 |
|---|---|---|
| ABC001 | MNP004 | XYZ001 |
| ABC002 | MNP005 | XYZ002 |
| ABC003 | MNP006 | |

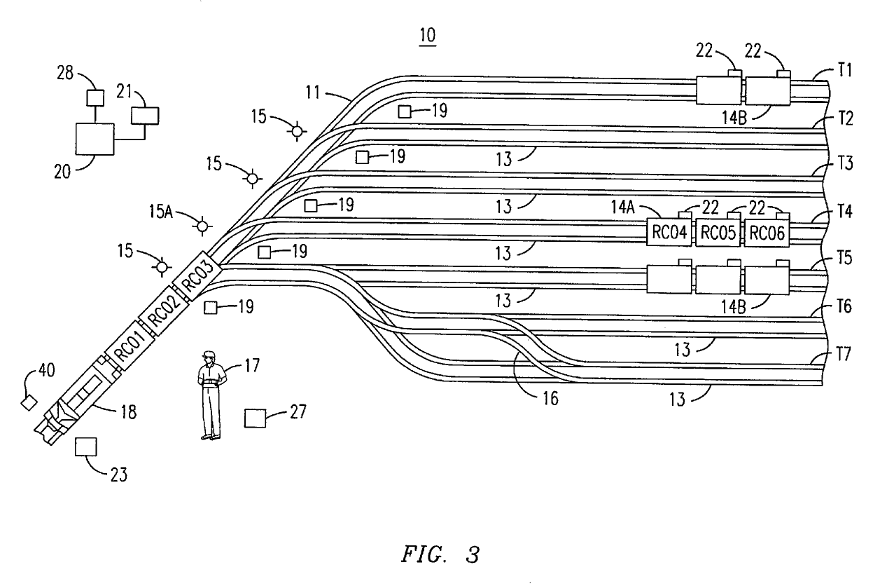

With respect to FIG. 4, the trains as moved so the railcars 14 in the train are positioned onto track T1. As described above, as the wheels or axles 26 pass the sensors 19 on track T1, the sensors 19 and controller 20 count the wheels or axles 26 to determine the number and identity of the rail cars 14 pushed onto track T1. In this example, twelve axles are counted; therefore, the controller 20 determines that the three railcars 14 (MNP001, MNP002 and MNP003) are on track T1. The controller 20 may also access database 21 to find that T1 already has railcars 14B identified as ABC001 and ABC002, with the railcar 14B identified as ABC002 between railcar MNP003 and ABC001.

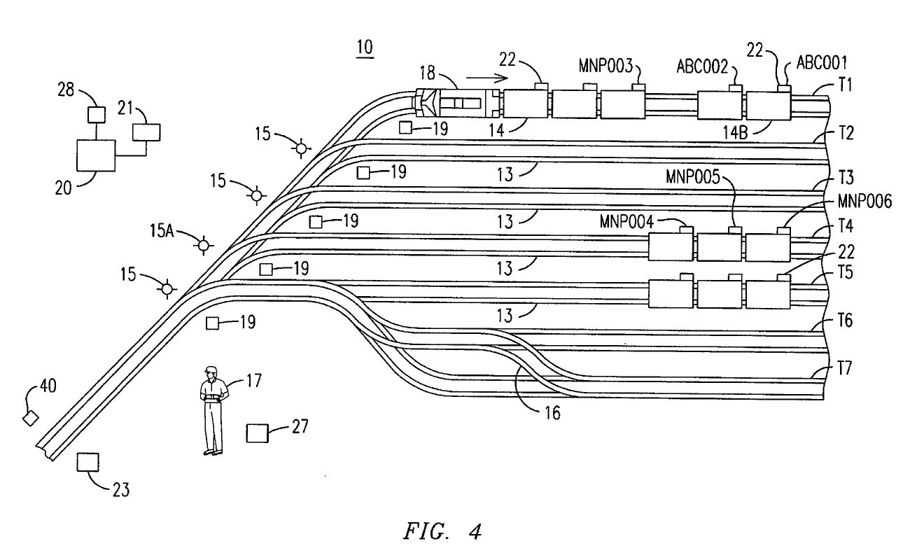

As shown in FIG. 5, the railcars 14B (ABC001 and ABC002) have been linked to the train 12, which has exited track T1. As described above, as the five railcars, including railcars 14 pass sensors 19 at track T1, the sensors 19 and controller 20 count the wheels or axles 26 on these railcars 14. The sensors 19 transmit signals 25 indicating the direction of movement (off the track) and the number of wheels or axles 26 passing the sensors 19. The controller 20 counts twenty wheels or axles 26, because the two railcars 14B (ABC001 and ABC002) have been linked to the train 12. The controller 20 is programmed to determine that eight axles 26 have been added to the train 12, which axles 26 are associated with the railcars 14B (ABC001 and ABC002) and no railcars 14B remain on track T1. Accordingly, the controller 20 may update the sequence of the railcars 14 and 14B in the train 12 and the railcar count may be updated as reflected in Table VI below:

TABLE VI

| RAILCAR/LOCO IDENTIFIER | RAILCAR/LOCO COUNT |
|---|---|
| MNP001 | RC01 |
| MNP002 | RC02 |
| MNP003 | RC03 |
| ABC002 | RC04 |
| ABC001 | RC05 |

The controller 20 may be programmed to update the inventory database 21 to reflect that the two railcars 14B identified as ABC001 and ABC002 have been removed from the track T1 as reflected in the below Table VII:

TABLE VII

| TRACK 1 | TRACK 4 | TRACK 5 |
|---|---|---|
| | MNP001 | XYZ001 |
| | MNP002 | XYZ002 |
| | MNP003 | XYZ003 |

Thus, according to the above described embodiments of the invention, the identification of a train, including the identity of each railcar and the sequence in which the railcars are linked together from the lead railcar to the locomotive is initially provided to the controller 20. In addition, a database 21 is provided that includes data relative to the identity, track location, and the sequence of the railcars 14B on each track 13 in the classification yard 10. Sensors 19 positioned at points or locations where railcars 14 may enter or exit a track 13 detect when a railcar 14 has entered or exited a track 13. The controller 20 is programmed to count the number of railcars 14 entering or exiting a track 13 and the sequence in which the railcars enter or exit a track. In this manner the controller 20 is able to update the sequence of the railcars in the train 12 when railcars are added or dropped; and, update the inventory data relative to the identity railcars 14B, the track location for each railcar 14B and the sequence of the railcars 14B on each track 13.

In addition, the system may also include a sensor 40 shown in FIGS. 1 and 5, positioned at an area in the rail yard 10 where the train 12 exits the rail yard. As the train 12 exits the rail yard 10, the sensor 40 counts the railcars 14 and an AEI reader 32 identifies the railcars 14 by their identifiers. The controller 20 may then confirm the sequence of the railcars 14 in the train 12 that is exiting the rail yard 10, and confirms that these railcars 14 are no longer listed in the rail yard inventory database 21.

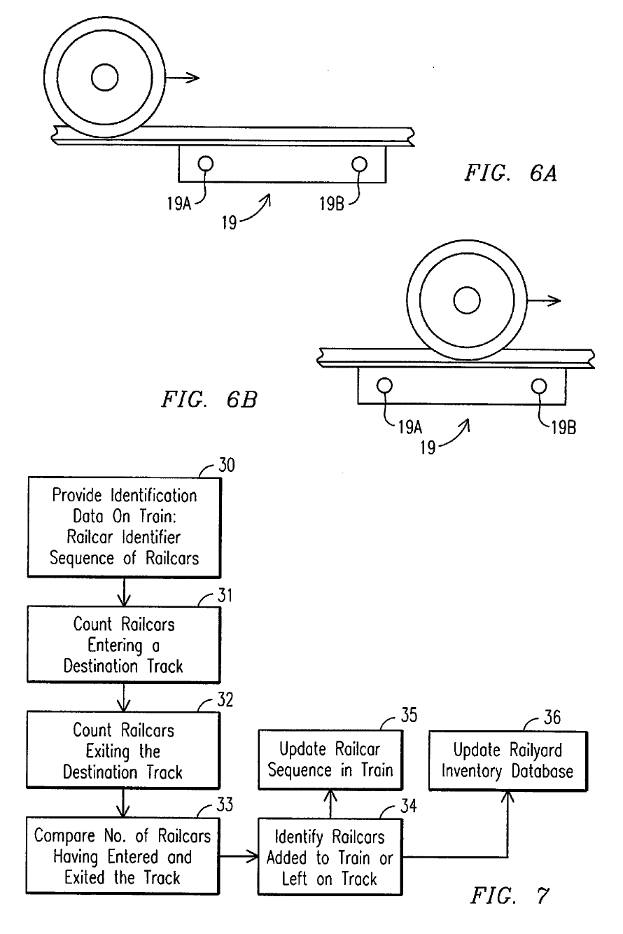

Embodiments of the invention may also be described as a method for tracking rail yard inventory. With respect to FIG. 7, there is illustrated a flow chart providing steps that may be found in the method. The method is not limited to the specific steps shown in the flowchart, which may include more or fewer steps. In addition, the invention is not necessary limited to the sequence of steps shown in FIG. 7.

In step 30 data relative to the train identification including the identifier data for each railcar and the sequence in which the railcars 14 linked together and to the locomotive 18 is entered in the controller 20. In step 31, the railcars 14 in a train 12 are counted as they enter a destination track 13; and, in step 32 the railcars 14 are counted as they exit the track. In an embodiment, the step of counting may include detecting movement of the railcars on the tracks at an area of a track where a railcar enters or exits a track; and, the movement is detected using a plurality of sensors wherein each sensor is positioned adjacent to a switch in the rail yard.

In step 33, the number of railcars 14 having entered the track 13 is compared to the number of railcars 14 having exited the track 13. Depending whether railcars 14 have been added or dropped, in step 34 the railcars 14 that have been added to the train 12 are identified, or the railcars 14 that were left remaining on the track 13 are identified. In steps 35 and 36, the railcar sequence in the train 12 is updated, and a rail yard inventory database is updated including the identity of each railcar, the track location of each railcar and the sequence in which the railcars 14 are arranged on a given track 13. In this manner, the rail yard inventory is tracked and updated as railcars are added or removed from the rail yard.

Embodiments of the invention may also include a computer readable memory medium that stores a program for tracking a rail yard inventory that includes a plurality of railcars moved and arranged on a plurality of tracks within rail yard and each track is associated with a destination of the railcars on the track. The computer program comprises a computer module for providing data relative to a train in the rail yard, the data comprising a total number of railcars in the train, an identifier for each railcar in the train, and a sequence in which the railcars are linked together. In addition a computer module may count the number of railcars that enter and exit each track in the rail yard; a computer module also identifies each railcar that enters and exits each track in the rail yard; and, a computer module for stores in a memory: (i) for each track in the rail yard, data relative to the number of railcars in the train having entered and exited a track in the rail yard, the identifier for each railcar having entered and exited the track, and the sequence in which railcars are arranged remaining on the track after the railcars have exited the track; and (ii) the sequence in which railcars are linked in the train. The module for providing identification data relative to the railcars may comprise a module for reading the data from a data storage device on each railcar and transmitting the data to a computer module for storing in the memory in the format of a railcar sequence of the train.

The module for counting comprises program instructions for controlling a plurality of sensors to detect movement of the railcars on the tracks at an area of a track where a railcar enters or exits a track, and each sensor is positioned adjacent to a switch in the rail yard. In addition, the computer readable memory medium may further comprise a computer module for updating the memory and data in the memory relative to the number of railcars in the train having entered and exited a track in the rail yard, the identifier for each railcar having entered and exited the track, the sequence in which the railcars are linked together in the train, and the sequence in which the railcars are linked remaining on the track each time a train adds railcars to the train or drops railcars from the train.

The module for storing comprises a computer module with a database having data relative to an identification of a track on which each railcar in the rail yard is positioned, the identifier for each railcar, and the sequence in which the railcars are linked on each track in the rail yard. In addition, the module for counting comprises a computer module for counting the number of railcars entering a track, counting the number of railcars exiting the same track, and comparing the number of railcars having entered the track to the number of railcars exiting the track to determine the number of railcars in the train and the number of railcars remaining on the track.

The computer readable memory medium may also include a computer module for updating the memory to include data relative to the sequence of railcars in the train; and, a computer module for updating the data in the database to include data relative the sequence of the railcars remaining on the track.

Embodiments described above may be implemented on a suitable computer system, controller, memory, or generally a computer readable medium. For example, the steps of the methods described above may correspond to computer instructions, logic, software code, or other computer modules disposed on the computer readable medium, e.g., floppy disc, hard drive, ASIC, remote storage, optical disc, or the like. The computer-implemented methods and/or computer code may be programmed into an electronic control unit of an engine, a main control system of the locomotive, a remote control station that communicates with the locomotive unit, or the like, as described above.

While various embodiments of the present invention have been shown and described herein, it will be obvious that such embodiments are provided by way of example only and not of limitation. Numerous variations, changes and substitutions will occur to those skilled in the art without departing from the teaching of the present invention. Moreover, unless specifically stated, any use of the terms first, second, selected, etc. do not denote any order or importance, but rather the terms first, second, selected, etc. are used to distinguish one element from another. Accordingly, it is intended that the invention be interpreted within the full spirit and scope of the appended claims.

What is claimed is:

1. A system for tracking a vehicle inventory in a staging yard wherein a plurality of the vehicles are connected in a series and are moved and arranged on a plurality of designated pathways in the staging yard by a powered vehicle, the system comprising:
a plurality of sensors positioned in the staging yard, wherein each sensor is associated with a designated pathway in the staging yard for detecting a vehicle entering or exiting the pathway and transmits one or more signals indicating the vehicle has entered or exited the pathway and an identification of the associated pathway; and
one or more controllers having data relative to the connected series of vehicles in the staging yard, said data comprising a total number of vehicles in the series and a sequence in which the vehicles are linked together and identified relative to a reference vehicle;
wherein the one or more controllers, responsive to movement of the vehicles in the staging yard and to the signals received from the sensors, store in a memory the number of vehicles from the connected series having entered or exited each pathway in the staging yard, and the sequence in which the vehicles are arranged on each pathway in the staging yard.

2. The system of claim 1, wherein the signals transmitted from the sensors indicate respective directions of movement of the vehicles on the pathways.

3. The system of claim 1, wherein:
vehicles are added to the series from the designated pathways and/or removed from the series for arrangement on the designated pathways; and
as vehicles are added or removed from the series, the controller is configured to create and store updated data relating to the series that includes the total number of vehicles in the series and a sequence in which the vehicles are linked together from a lead vehicle to the powered vehicle

4. The system of claim 1, further comprising a database accessible by the controller, wherein the database includes, for each pathway, data relative to the total number of vehicles on each pathway and the sequence in which the vehicles are arranged on each pathway.

5. The system of claim 4, wherein the one or more controllers are configured to update the database when vehicles are added to any pathway or removed from any pathway.

6. The system of claim 4, wherein the one or more controllers, responsive to signals received from the sensors, count the number of vehicles in the series that enter a selected pathway and count the number of vehicles that exit the selected pathway to determine the total number of vehicles in the series when the vehicles have exited the selected pathway and to determine the sequence of the vehicles in the series.

7. The system of claim 6, wherein the one or more controllers determine the total number of vehicles remaining on the selected pathway when the vehicles exit the pathway and the sequence of the vehicles on the selected pathway if vehicles remain on the selected pathway.

8. The system of claim 1, wherein the staging yard includes an automated equipment reader positioned at an entrance of the staging yard that reads vehicle identifier data for each vehicle from an automated equipment tag on each vehicle, and the automate equipment reader transmits the identifier data to the controller which creates a vehicle sequence for the series of vehicles including the vehicle identifier data for each vehicle.

9. The system of claim 1, wherein the staging yard is a rail yard comprising a plurality of tracks, and the series of connected vehicles is a train that includes a plurality of connected railcars moved in the rail yard by a locomotive, and the rail yard further comprises switches for transferring the vehicles between tracks.

10. A method for tracking a rail yard inventory that includes a plurality of railcars moved and arranged on a plurality of tracks within rail yard and each track is associated with a destination of the railcars on the track, the method comprising:
providing data relating to a train in the rail yard, the data comprising a total number of railcars in the train, an identifier for each railcar in the train, and a sequence in which the railcars are linked together; counting the number of railcars that enter and exit each track in the rail yard;
identifying each railcar that enters and exits each track in the rail yard; and,
storing in a memory: (i) for each track in the rail yard, data relative to the number of railcars in the train having entered and exited a track in the rail yard, the identifier for each railcar having entered and exited the track, and the sequence in which railcars are arranged remaining on the track after the railcars have exited the track; and (ii) the sequence in which railcars are linked in the train.

11. The method of claim 10, wherein the step of counting comprises detecting movement of the railcars on the tracks at an area of a track where a railcar enters or exits a track.

12. The method of claim 10, wherein railcar movement is detected using a plurality of sensors wherein each sensor is positioned adjacent to a switch in the rail yard.

13. The method of claim 10, further comprising updating the data in the memory relative to the number of railcars in the train having entered and exited a track in the rail yard, the identifier for each railcar having entered and exited the track, the sequence in which the railcars are linked together in the train, and the sequence of the railcars are linked remaining on the track each time a train adds railcars to the train or drops railcars from the train.

14. The method of claim 10, wherein the data is stored in, or in association with, a database having data relative to the track on which each railcar in the rail yard is positioned, the identifier for each railcar, and the sequence in which the railcars are arranged on each track in the rail yard.

15. The method of claim 14, wherein the step of counting comprises counting the number of railcars entering a track, counting the number of railcars exiting the same track, and comparing the number of railcars having entered the track to the number of railcars exiting the track to determine the number of railcars in the train and the number of railcars remaining on the track.

16. The method of claim 15, further comprising updating the memory to include data relative to the sequence of railcars in the train.

17. The method of claim 15, further comprising updating the data in the database to include data relative the sequence of the railcars remaining on the track.

18. The method of claim 10, wherein the step of providing data relative to the identification of the railcars comprises reading the data from a data storage device on each railcar and transmitting the data for storing in the memory in the format of a railcar sequence of the train.

19. A computer readable memory medium that stores a program for tracking a rail yard inventory that includes a plurality of railcars moved and arranged on a plurality of tracks within rail yard and each track is associated with a destination of the railcars on the track, the computer program comprising:
a computer module for providing data relative to a train in the rail yard, the data comprising a total number of railcars in the train, an identifier for each railcar in the train, and a sequence in which the railcars are linked together;
a computer module for counting the number of railcars that enter and exit each track in the rail yard;
a computer module for identifying each railcar that enters and exits each track in the rail yard; and,
a computer module for storing in a memory: (i) for each track in the rail yard, data relative to the number of railcars in the train having entered and exited a track in the rail yard, the identifier for each railcar having entered and exited the track, and the sequence in which railcars are arranged remaining on the track after the railcars have exited the track; and (ii) the sequence in which railcars are linked in the train.

20. The computer readable memory medium of claim 19, wherein the module for counting comprises program instructions for controlling a plurality of sensors to detect movement of the railcars on the tracks at an area of a track where a railcar enters or exits a track, wherein each sensor is positioned adjacent to a switch in the rail yard.

21. The computer readable memory medium of claim 21, further comprising a computer module for updating the memory and data in the memory relative to the number of railcars in the train having entered and exited a track in the rail yard, the identifier for each railcar having entered and exited the track, the sequence in which the railcars are linked together in the train, and the sequence in which the railcars are linked remaining on the track each time a train adds railcars to the train or drops railcars from the train.

22. The computer readable memory medium of claim 19, wherein the module for storing comprises a computer module with a database having data relative to an identification of a track on which each railcar in the rail yard is positioned, the identifier for each railcar, and the sequence in which the railcars are linked on each track in the rail yard.

23. The computer readable memory medium of claim 22, wherein the module for counting comprises a computer module for counting the number of railcars entering a track, counting the number of railcars exiting the same track, and comparing the number of railcars having entered the track to the number of railcars exiting the track to determine the number of railcars in the train and the number of railcars remaining on the track.

24. The computer readable memory medium of claim 22, further comprising a computer module for updating the memory to include data relative to the sequence of railcars in the train.

25. The computer readable memory medium of claim 23, further comprising a computer module for updating the data in the database to include data relative the sequence of the railcars remaining on the track.

26. The computer readable memory medium of claim 19, wherein the module for providing identification data relative to the railcars comprises a module for reading the data from a data storage device on each railcar and transmitting the data to a computer module for storing in the memory in the format of a railcar sequence of the train.
